(19) United States
(12) Patent Application Publication
(10) Pub. No.: US 2013/0147430 A1
(43) Pub. Date: Jun. 13, 2013

(54) DESIGN AND PRODUCTION OF A SYSTEM FOR WIRELESSLY CHARGING THE BATTERIES OF A ROBOT

(71) Applicant: Mhoamed Zied Chaari, Sfax (TN)

(72) Inventor: Mhoamed Zied Chaari, Sfax (TN)

(21) Appl. No.: 13/818,698

(22) PCT Filed: Aug. 19, 2011
(86) PCT No.: PCT/TN2011/000002

§ 371 Date: Feb. 25, 2013

(30) Foreign Application Priority Data
Aug. 23, 2010 (TN) TN 2010/0389

(51) Int. Cl. H02J 7/02

(52) U.S. Cl. CPC H02J 7/025
USPC 320/108

(57) ABSTRACT

In the context of expanding the scope of the inspection field and in order to improve said field, the present invention is provided, which relates to a robot that inspects a pipeline, but may encounter certain problems during said operation. For this purpose and in order to avoid said major risk, a system for wirelessly charging the batteries of said robot is used, wherein the pipeline is used as a waveguide and as a Faraday cage in order to improve the performance of the inspection system.

### PROBLEMATIC

In the oil sector, the transport of crude hydrocarbon is done through steel tubes of different types and diameters both in field territory and maritime. These methods (pipelines) remain the most efficient and profitable.

Some improvements in treatment and coating have been applied to these tubes through time to the circumference and along tubes to protect them and increase their lifespan. This pipeline, which is an assembly of tubes, will be submitted automatically to testing and non-destructive testing (NDT) that allow us to verify and justify the quality of welds applied and used.

Advanced techniques for this type of control is set to put robots inside the section with a very advanced technology to help us diagnose the pipeline's wall. But during the inspection, the robot encounters a problem of autonomy (depletion of its battery). We note for example: to detect the state of welding inside the pipeline, the robot must be equipped with an X-Ray generator or gamma or other sensor, resulting in this case a rapid exhaustion of its battery, which will make the robot remaining blocked inside the pipeline.

Corrective solutions adopted to remove the robot are very expensive and require enough time and effort that may affect the progress and subsequently increase the cost of the project.

### PRIOR TECHNIQUES

Address the problem of exhaustion of the robot batteries, several solutions have been implemented such as:
Sending inside the pipeline another robot savior to grab the inspection robot and bring it out of that section of the pipeline; however the second robot can also be blocked inside.
Use of electric cables instead of batteries. A technological solution that it's used but it has also its inconveniences: voltage drop for pipe lines and the risk of explosion in case of rubbing between the cable and the pipe, if it is carrying a gaseous product.→Unsecured and unsecure solution.
Charging the batteries by wireless transfer of electrical energy. This solution is applicable in case of short distances using air as a conductor of energy.→Not applicable to all cases.
Charging the batteries by induction effect cannot be functional over long distances. This technology cannot be applied to a Faraday shield due to the presence of eddy current.

### A BRIEF DESCRIPTION OF THE FIGURES

The present invention will be better understood thanks to the following detailed description and that refers to the accompanying drawings, which are given as non-limiting example, namely:

FIG. 1 illustrates a block diagram of a wireless charger by microwave.

FIG. 2 illustrates a schematic diagram of use of the pipeline as a waveguide.

FIG. 3 illustrates the attenuation of a wave according to the frequency.

FIG. 4 illustrates the structural diagram of the Electromagnetic wave generator.

FIG. 5 illustrates the synoptic diagram of our converter RF/DC.

FIG. 6 illustrates a block diagram of a microwave-DC converter.

FIG. 7 illustrates a block diagram of microwave-DC converter.

FIG. 8 illustrates the physical schema of a horn antenna.

FIG. 9 illustrates the process of the invention.

FIG. 10 illustrates the connection system between the antenna and the rectification circuit.

FIG. 11 illustrates the connection system between the antenna and the magnetron.

### DETAILED DESCRIPTION OF THE INVENTION

The present invention consist on charging wirelessly the batteries of an intelligent robot existing inside the pipeline based on the principle of transfer of electrical energy by using a microwave emitting source with directional antenna and rectification circuit fixed to the robot. This exploration allows us to work on very large lengths of pipes. (d=6 km).

The process of the invention is illustrated by the diagrams in Figures from 1 up to 9.

In order to charge wirelessly the batteries of the robot, we are based on the principle of Electric Power transferred by microwave. The advantages of this technique are the following: the ability of long-distance, directive antenna, security and a miniature antenna.

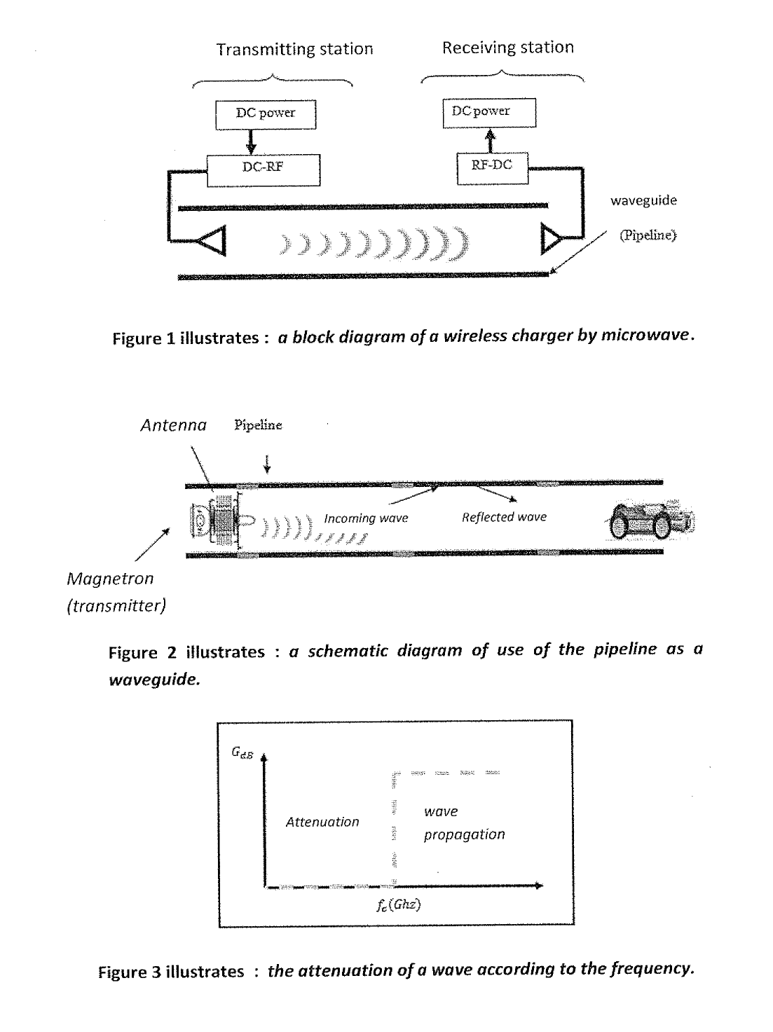

As shown in FIGS. 1 and 2, the wireless charger of batteries by microwaves energy has three parts:
A transmission station at the beginning of the pipeline constituted by an AC/DC converter, a DC/RF converter (magnetron) and a transmitting antenna.
The pipeline is used as a waveguide, and as a Faraday cage.
A receiving station at the level of the robot constituted by a RF/DC converter (rectenna) and a receiving antenna.

As shown in FIG. 2, when the microwave energy is spread over a large distance between two points, it is possible to optimize the transmission by wave guiding from the transmitter to the receiver (robot).

As the waves are strongly reflected by the metal surfaces (pipeline), in order to perform guidance we install a metallic pipe from the transmitter to the receiver.→The waves emitted are then confined to the inside of the pipe.

The pipeline behaves like a Faraday cage (FIG. 1) and this phenomenon can guarantee things that are very important:
Focusing the electromagnetic energy into the pipeline.
The protection of employers and the environment against the Electromagnetic radiation.
The transfer of electric energy over long distances, that is to say, the robot can inspect large distances even if the battery is low.

To determine if a mode is spreading in a waveguide, we must calculate its cutoff frequency “fc” and compare it with the working frequency “f”:
If “f” is higher than “fc”, then that mode is propagative.
Otherwise we have an attenuation of energy.

A waveguide behaves then like a high pass filter as illustrated in FIG. 3.

The principle of the transmitter of electromagnetic waves is represented by the block diagram of FIG. 5. A transmission system (transmitter) having a source of electromagnetic energy is capable of propagating radiation in the pipeline to a great distance.

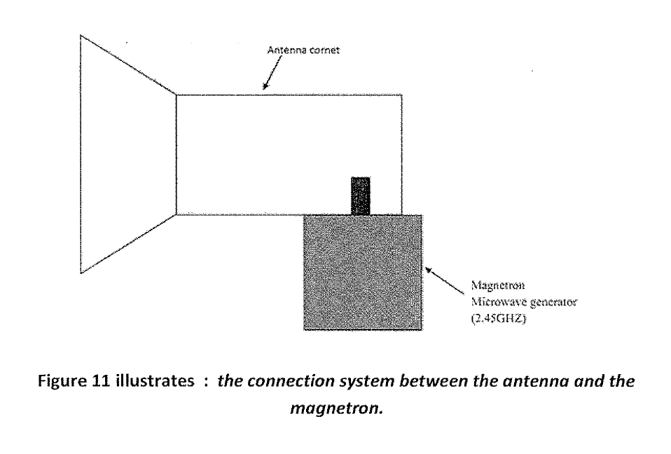

This horn antenna (as shown in FIG. 11) is connected to the output of the magnetron in order to focus as much energy inside the pipeline and to minimize the radio frequency radiation outside of the pipeline.

The magnetron is composed of a cylindrical anode consisting cavities. These cavities are found in the axis of a heating cathode. The more cavities, more the performance is high.

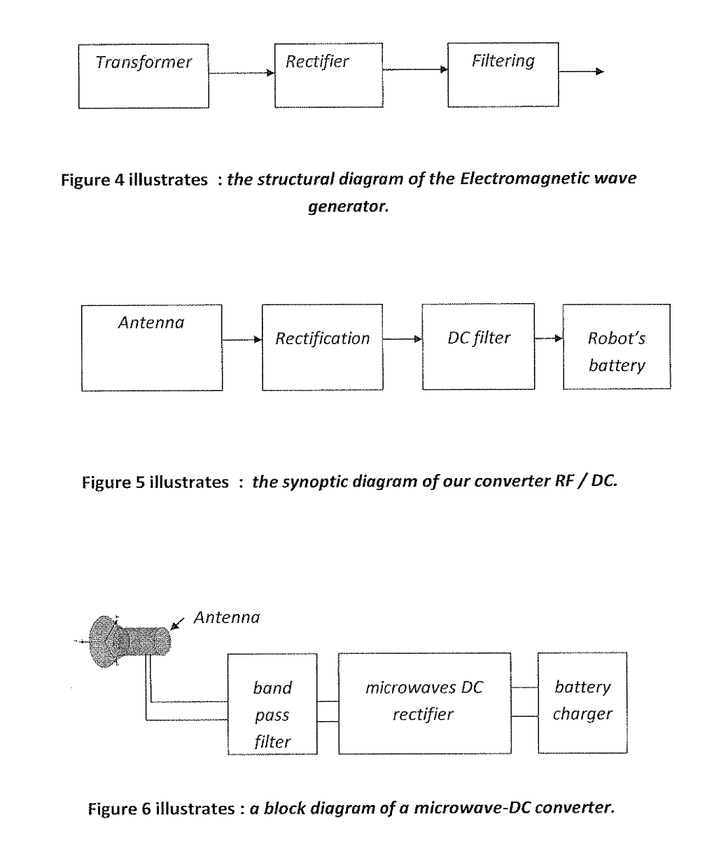

Electrical energy in the form of an AC voltage (high and low voltage) is converted into a DC voltage by a transformer, diode and capacitor (as shown in FIG. 4). The high voltage makes a powerful electromagnetic field. The low voltage makes an electric field which will be transformed into electromagnetic waves emitted by the antenna.

Upon receipt, we must capture the maximum of electromagnetic energy that is flowing in the pipeline to charge the batteries of our inspection robot. The principle of our system is represented by the synoptic diagram in FIG. 5.

The energy converter RF/DC (as shown in FIGS. 6, 7 and 10) is composed of four interconnected blocks:
The first block is the receiving antenna, which is fully responsible for the capture of all the microwaves energy.

The antenna is a device for remotely sensing the electromagnetic waves in a reception apparatus. The directive antenna also possesses a profit very elevated.
The second block is the rectification circuit.

The recovery function of energy is generally provided by a rectifier that can retrieve a DC voltage from the radio frequency carrier received by an antenna network. The rectifier unit is generally an assembly based of Schottky diodes characterized by a fast switching time. The receiving device can retrieve the microwaves energy and convert it into electrical energy (continue).
The third block is a filtering stage.

The filtering circuit the most widespread is the one using capacitors and coils. It is connected after the recovery.
The fourth block is the battery charger.

This charger is adjustable in voltage and current. It uses a voltage regulator for adjusting the maximum voltage of the adjustable charge and the current limiting function to define the maximum load current to be adapted according to the type and the capacity of the energy storage of the robot.

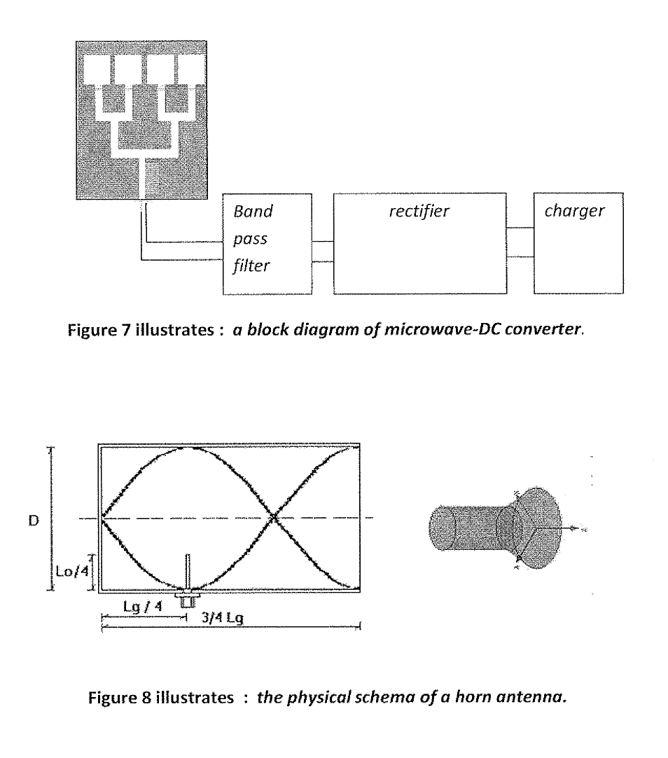

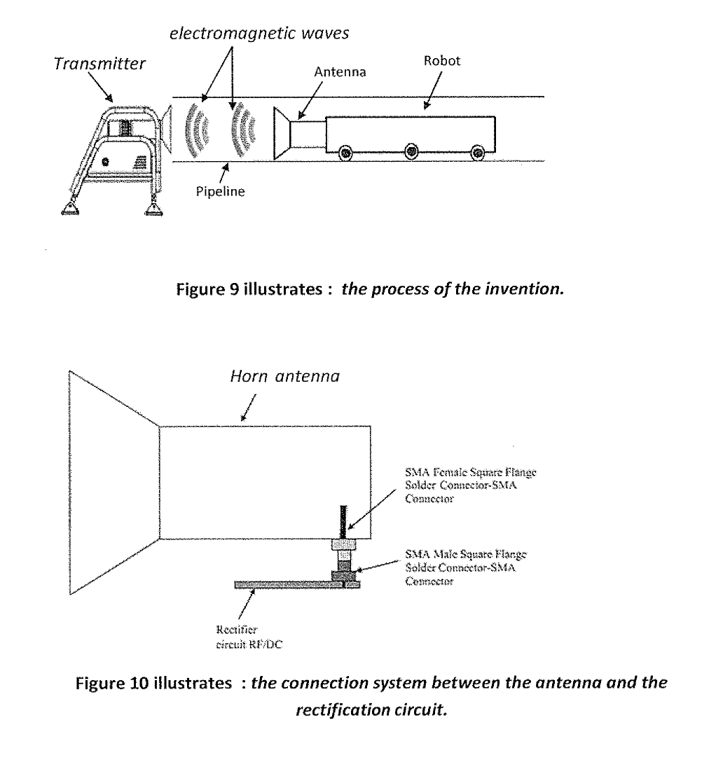

As shown in FIG. 7, the determination of the geometry of the receiving antenna network consists in putting in network the primary radiating elements in a particular geometric layout to best meet the requirements in terms of gain, maximum size and radiation patterns. The goal here is to select the total number of elements and the spacing between them to achieve desired levels of gain.

If the sources are very close to each other, a coupling phenomenon reduces the gain value. When they are too distant network lobes appear and also reduce the gain in the axis.

The power radiated uniformly covers the entire upper surface of the antenna.

We conduct achievements of an antenna with a network of patches in various forms, to improve more gain and directivity.

The patch antenna is a very interesting device in our application that can convert electromagnetic waves into electrical energy. The amount of energy recovered depends on the characteristics of the antenna. So in this part we will deal with the different forms of antenna.

Increasing the number of stage recovery, we can theoretically achieve a necessary output voltage.

As shown in FIG. 8, we use a horn antenna to retrieve energy. The circular waveguide is a device widely used for the propagation of guided waves. Its quality of recovery is excellent. For this reason, it is used in high frequency. Its use is widespread in hyper frequencies.

The horn antenna is the transformer of the Electromagnetic guided power into the radiated power. The wave is thus naturally projected into the space. The horn is used to make the adaptation and impedance of the horn and the vacuum

1. A Wireless battery charging device of an intelligent inspection robot existing inside the pipeline, based on the transfer principle of electrical energy into microwaves, by using an emitting source with a directional antenna and a rectification circuit fixed on a receiving antenna on the robot.

2. A device according to claim 1, characterized in that it comprises:
A transmitting station at the beginning of the pipeline constituted by an AC/DC converter, a DC/RF converter (magnetron) and a transmitting antenna.
A pipeline used as a waveguide, and as a Faraday cage.
A receiving station at the level of the robot constituted by a converter RF/DC and a receiving antenna.

3. A device according to claim 1, characterized in that if the frequency increases, the transmission range of contactless energy increases.

4. A device according to claim 1, characterized in that the transfer of energy in the interior of the pipeline “waveguide” is done whatever the pipe is straight, or in the presence of zigzags “bends”.

5. A device according to claim 2, characterized in that the transmitter has several transmission frequencies and also several power levels.

6. A device according to claim 2, characterized in that the magnetron can change its slide way position in the waveguide of the horn antenna at a groove in order to change the transmission power, and modify the propagation mode.

7. A Device according to claim 2, characterized in that the antenna has a groove for pivoting the axis of the magnetron according to 360°.

8. A device according to claim 2, characterized in that a heater is installed around the transmitting antenna to dissipate thermal energy and cool down the antenna.

9. A device according to claim 1, characterized in that the dimension of the antenna is proportional to the dimension of the pipeline.

10. A device according to claim 2, characterized in that the transmission frequency is higher than the cutoff frequency of the pipeline.

11. A device according to claim 2, characterized in that the energy is propagated inside Faraday cage “pipeline”.

12. A device according to claim 2, characterized in that the antenna has grooves for sliding and pivoting the probe according to the power recovered by the rectifier.

13. A device according to claim 2, characterized in that it is provided with a DC microwave converter with high efficiency.

14. A device according to claim 1, characterized in that the transmission system is based on the microwave energy.

15. A device according to claim 1, characterized in that the DC microwave converter is connected to the battery charger.

16. A device according to claim 1, characterized in that a communication system exists between the energy transmission station and the inspection robot of the pipeline.
